(19) United States
(12) Patent Application Publication
(10) Pub. No.: US 2013/0133445 A1
(43) Pub. Date: May 30, 2013

(54) CONTROL MOMENT GYROSCOPE DESATURATION IN AIRCRAFT

(71) Applicant: Christopher Jan Heiberg, Sunset Beach, CA (US)

(72) Inventor: Christopher Jan Heiberg, Sunset Beach, CA (US)

(21) Appl. No.: 13/305,922

(22) Filed: Nov. 29, 2011

(51) Int. Cl. G01C 19/52; G01C 19/02

(52) U.S. Cl. 74/5.34; 74/5.43

(57) ABSTRACT

A method for adjusting a control moment gyroscope array includes receiving a stream and directing the stream to adjust momentum in the control moment gyroscope.

### BACKGROUND

Embodiments of this disclosure generally relate to a control moment gyroscope (CMG), and more particularly, to managing momentum in CMGs using vectored air and/or bleed exhaust from a propulsion system.

CMGs may be commonly employed in aircraft systems for controlling attitude. A generalized CMG may include a housing that supports an inner gimbal assembly (IGA). The IGA may include a rotor having an inertial element, for example, a rotating ring or cylinder coupled to a shaft. Spin bearings may be disposed around the shaft ends to facilitate the rotational movement of the shaft, which may be rotated about a spin axis by a spin motor.

The IGA, in turn, may be rotated about a gimbal axis by a torque module assembly (TMA) mounted to a first end of the CMG housing. To facilitate the rotational movement of the IGA, gimbal bearings may be disposed between the IGA and the CMG housing. A sensor module assembly (SMA) may also be mounted to a second portion of the CMG housing opposite the TMA to deliver electrical signals and power to the IGA. The CMG may include a number of sensors suitable for determining rotational rate and position of the IGA.

A CMG may include a spinning rotor and one or more motorized gimbals that tilt the rotor's angular momentum. A plurality of CMGs may be arranged to form an array. Control of the CMGs in the array may be performed individually or in concert as part of a momentum management system.

Losses and external disturbances may saturate the momentum in a CMG array. The saturated moment may result in loss of effectiveness of the CMG for control that may prevent desired attitude. By desaturating, the CMG momentum may be brought back into nominal values and function properly.

Therefore, it would be desirable to provide a system and method for desaturating CMGs in aircraft.

### SUMMARY

A method for adjusting a control moment gyroscope array on board an aircraft includes receiving a stream and directing the stream to reduce momentum in the control moment gyroscope.

A control moment gyroscope array has saturated angular momentum and a channel receiving airflow for removing the saturated angular momentum.

A system has a control moment gyroscope array and at least one channel vectoring thrust to act on the control moment gyroscope array for desaturating angular momentum.

The features, functions, and advantages may be achieved independently in various embodiments of the disclosure or may be combined in yet other embodiments.

### BRIEF DESCRIPTION OF THE DRAWINGS

Embodiments of the disclosure will become more fully understood from the detailed description and the accompanying drawings, wherein:

FIG. 1 is an array of exemplary control moment gyroscopes (CMGs);

FIG. 2 is a number of illustrative planes formed by rotating the CMGs;

FIG. 3 is an exemplary graph providing momentum vectors of the CMGs;

FIG. 4 is an exemplary graph providing vector sums in a zero momentum state;

FIG. 5 is an exemplary graph providing residual momentum that is non-zero;

FIG. 6 is an illustrative system for mitigating residual momentum in CMGs;

FIG. 7 is an illustrative system for desaturating the CMGs through an airstream;

FIG. 8 is an exemplary block diagram providing generalized components for desaturating the CMGs; and

FIG. 9 is a flow chart providing illustrative processes for desaturating the CMGs.

### DETAILED DESCRIPTION

Control moment gyroscopes (CMGs) may be used for many applications including platform stabilization and vibration control of machinery. CMGs may be commonly used in transportation systems such as spacecraft, aircraft or watercraft. As part of their use, losses and periodic disturbances may result in momentum buildup in spacecraft for which magnetic torque rods or jets are used for desaturation. External disturbances may give rise to the accumulation of residual momentum. The residual momentum may build up to a point where the CMG array becomes saturated. When saturated, the useful torque and momentum transfer provided by the CMGs may be limited.

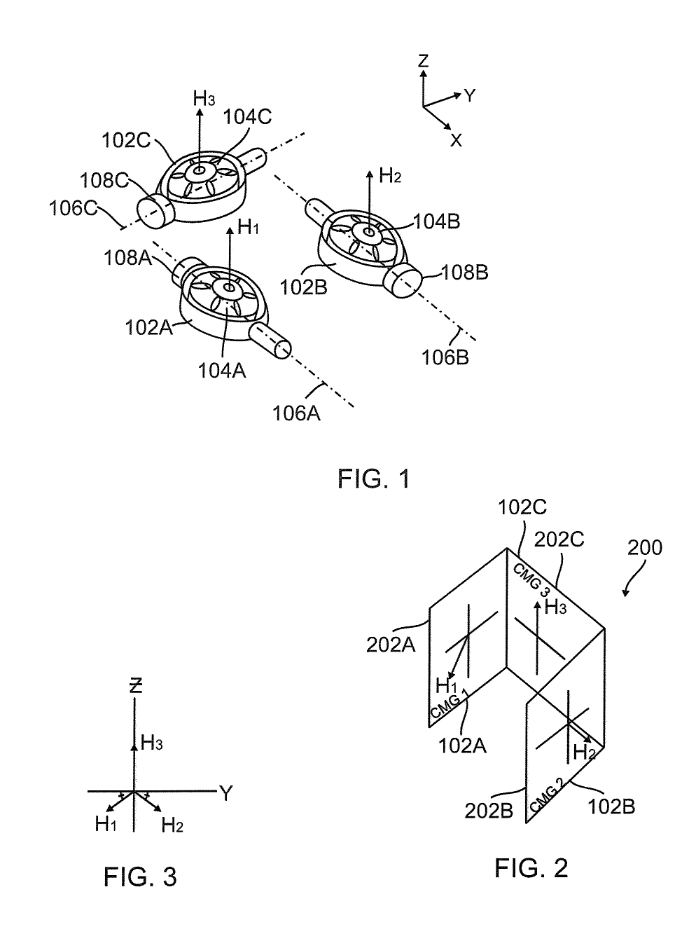

Typically, at least three CMGs may be used to perform three-axis stabilization as CMG momentum may be constrained to an aircraft. In one embodiment, two CMGs in a scissor-pair arrangement to control torque and momentum in one axis may be used. Referring to FIG. 1, an array of exemplary CMGs 102A, 102B and 102C (collectively 102) may be shown. The CMGs 102 may be in a box configuration with their momentum vectors oriented in a nominal +Z direction. Each CMG 102 may include an inner gimbal assembly (IGA) 104A, 104B and 104C (collectively 104) that has a rotational degree of freedom about its gimbal axis 106A, 106B and 106C (collectively 106).

The IGAs 104 may contain a rotating inertial mass (rotor) that may store angular momentum. This rotor 102 may be suspended in a rotating mount. The angular momentum vectors H₁, H₂ and H₃ of the IGAs 104 may be processed about their gimbal axis 106 thereby creating control torque. H₁ may be associated with CMG 102A, H₂ may be associated with CMG 102B and H₃ may be associated with CMG 102C. Gimbal actuation may be accomplished using a mechanism often called a torque module assembly (TMA) 108A, 108B and 108C (collectively 108). Each momentum vector H₁, H₂ and H₃ may be oriented in a plane formed by the rotation about each gimbal axis 106.

While multiple CMGs 102 have been shown, other configurations may exist. CMGs 102 may be single or multiple gimbaled devices. Applications requiring significant levels of torque may tend to have a single-gimbal in order to take advantage of what is often referred to as “torque multiplication”. Double gimbal devices may be used where low torque, high momentum may be required. Furthermore fewer or more CMGs 102 may be used that do not have to be constrained to a plane.

In FIG. 2, a number of illustrative planes 202A, 202B and 202C (collectively 202) formed by rotating each CMG momentum vector H₁, H₂ and H₃ for the CMGs 102 depicted in FIG. 1 may be shown. The momentum vector H₁ of CMG 102A may be provided in plane 202A. The momentum vector H₂ of CMG 102B may be provided in plane 202B, while the momentum vector H₃ of CMG 102C may be provided in plane 202C. The three planes 202 may form a box configuration 200.

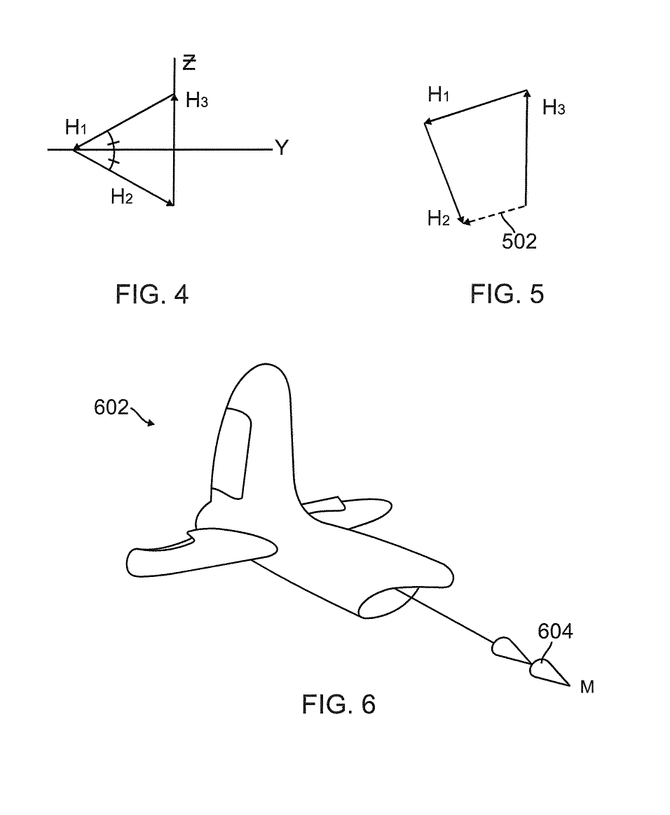

In one embodiment, the momentum vectors H₁, H₂ and H₃ may be oriented such that the net momentum for the CMGs 102 may be zero. Turning to FIG. 3, an exemplary graph providing momentum vectors H₁, H₂ and H₃ of the CMGs 102 may be shown. H₁ and H₂ may have momentum vectors angled at thirty degrees that may cancel their Y-axis components along with the vertical component of H₃ along the Z-axis. FIG. 4 may show how the momentum vectors H₁, H₂ and H₃ sum to a zero momentum state.

When saturated, the momentum is non-zero which may make the CMGs 102 loose effectiveness and control. When an array 102 is completely saturated, there is no amount of momentum that may be extracted in that particular direction (in the saturated direction). In one embodiment, “saturated” may describe when the momentum is above a threshold, but may be interchangeable with completely saturated. Utilization of CMG momentum in attitude control may include creating torque by rotating the individual CMG momentum vectors. That torque may be reacted by the host structure that in turn rotates. The relative rotation of the host structure may tend to balance the momentum in the CMG array 102. In other words, the host platform may rotate with momentum equal to and opposite that of the CMG array 102. In a condition where the host platform is at rest and the momentum of the CMG array 102 is non-zero, the residual may act to mitigate the amount of torque and momentum that may be used to control the angular attitude and rate of the host structure. Management of that momentum residual may be used to have effective attitude control so desaturation may be utilized. In rare cases, an operator or system may elect to create a bias momentum vector prior to a large momentum maneuver in order to extend the amount utilized in a maneuver, later to be desaturated towards a nominal, zero momentum state. The same methods may be utilized to desaturate a CMG array 102 and may be used to build up a momentum bias in anticipation of such a maneuver.

In FIG. 5, an exemplary graph providing residual momentum 502 may be shown. This residual momentum 502 may result from frictional losses, bias torque on the system or a number of other contributors. Ultimately, the residual momentum 502 may limit the amount of torque that may be extracted from the CMGs 102.

The combination of vectors H₁, H₂ and H₃ shown in FIG. 5 has a non-zero residual momentum 502. Residual momentum 502 in the CMG array 102 may be mitigated by applying an external torque in the direction equal to and opposite to the system. The torque may be provided through a process referred to as desaturation. The residual moment 502 of the CMGs 102 may be driven to a desired momentum state by generating a command equal to the difference between the desired state and the momentum residual times some gain. The Law of Conservation of Angular Momentum provides that the residual momentum 502 may be determined by summing the momentum of the platform and the momentum stored in the CMGs 102. In a zero residual momentum state, the platform and CMG momentum may be equal and opposite. The goal of desaturization may be to drive the residual momentum 502 in the CMGs 102 to zero or within a threshold of zero. A bias momentum state may be created in anticipation of a specific maneuver. When a bias momentum state is generated, the amount of momentum transfer may be extended beyond that available by initiating the maneuver from a zero-bias state.

In an aircraft 602, as provided in FIG. 6, utilizing dedicated or existing aero-control surfaces may be used to produce the torque 604 counter to the residual momentum 502 on the CMGs 102 when saturated. The torque 604 may be in a vectored direction that reduces the stored angular momentum in the CMGs 102. This airflow over the aero-control surface may produce positive torque 604 on the aircraft 602. In one embodiment, airflow over the tail section may be used.

As depicted, the aero-control surfaces of the aircraft 602 may produce a roll axis torque M 604 that may cancel a CMG residual momentum 502 in that direction. By utilizing existing sources of thrust from an aircraft 602, desaturation of residual momentum 502 may no longer require dedicated surfaces or thruster mechanisms. The system may be used in other vehicles having CMGs 102 such as watercraft. A stream of air or liquid may be used.

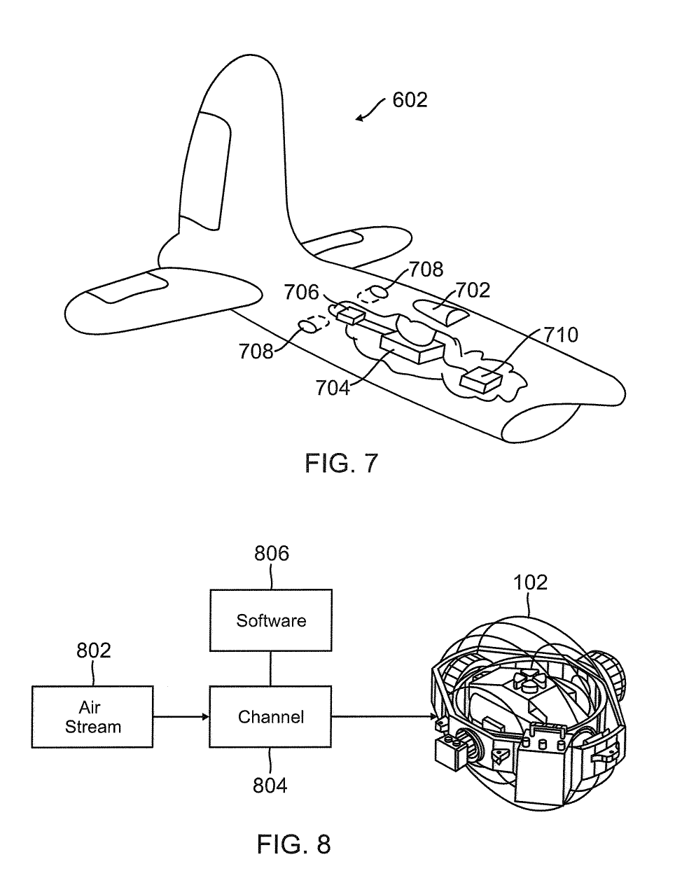

Turning to FIG. 7, an illustrative system for desaturating the CMGs 102 through an airstream may be shown. The airstream may be taken from outside the aircraft 602. In the shown embodiment, the airstream may be captured through an air intake 702. More than one air intake 702 may exist on the aircraft 602. The intake 702 may include a scoop that receives the airstream. The intake 702 may project from the outer surface of the aircraft 602, which may be designed to utilize the dynamic pressure of the airstream to maintain a flow of air. The airstream may be taken in through an under carriage of the aircraft 602.

The air intake 702 may re-direct air into a duct and manifold management system 704. The aircraft 602 may have a number of valves 706 that may receive the airstream from the duct and manifold management system 704. The airstream from the valves 706 may be directed in a manner that produces thrust via nozzles 708 strategically placed on the aircraft 602. The thrust may then be used to generate torque 604 to desaturate the CMGs 102.

While the system for desaturating the CMGs 102 is shown in the tail section of the aircraft 602, the system may be placed in other locations. For example, the air intake 702 and duct and manifold system 704 may be provided in a middle portion of the aircraft 602 or at least a portion thereof. Portions of the desaturation system may be placed in the wings of the aircraft 602.

In one embodiment, the thrust may be generated from another on-board source, for example, an auxiliary power unit (APU) within the aircraft 602. Bleed thrust from an engine exhaust or a dedicated gas or liquid pressure generating device may also be used. The amount of desaturation torque 604 to be generated may be calculated, commanded and controlled via a processor 710 that utilizes sensor input from the aircraft 602 and CMG sensors.

In FIG. 8, an exemplary block diagram providing generalized components for desaturating the CMGs 102 may be shown. The airstream 802 may be taken from a variety of sources. As shown above, the airstream may be taken from an external source. The airstream 802 may be received by a channel 804. The channel 804 may include the air intake 702, duct and manifold management system 704, valves 706 and nozzles 708.

As also shown, the airstream 802 may be taken from a propulsion device on the aircraft 602. The bleed air may be taken from a compressor of the propulsion device. The bleed air may then be provided to the channel 804. The channel 804, in this embodiment, may include fewer or more parts than that described above. For example, the airstream 802 may be directed to the nozzles 708 within the channel 804 without using the air intake 702, duct and manifold management system 704 and valves 706. In one embodiment, a combination of both the outside vectored air and the bleed air may be used.

In each, the channel 804 may have one or more nozzles 708. The nozzles 708 may be fixed. The fixed nozzles 708 may be selected to direct the airstream 802 to produce a desired torque 604 to desaturate the CMGs 102. For example, the nozzles 708 may be selected based on angle and amount of torque 604 that may be generated therefrom. Alternatively, the nozzles 708 may be maneuverable. The nozzles may be moved to direct the airstream 802 and to produce the desired torque 604.

By gimbaling the nozzles 708 within the channel 804 in a coordinated set of directions, torque 604 may be produced via a steering law or modulating the thrust from fixed nozzles 708 via a selection control law. Similarly, the torque 604 may be generated via commanding aero-control surfaces to generate a torque in a direction opposite to that of the residual 502 and for a duration to produce an equivalent momentum thereby reducing the residual 502 to a near or zero residual state.

In both the fixed and maneuverable nozzles 708, software 806 may be used to vector the airstream 802. The software 806 may also be used for detecting saturation within the CMGs 102. Sensors may be attached to the CMGs 102 where saturated angular momentum within it may be detected. Saturation may be calculated based on the known orientation of the gimbal axis 106 of the CMGs 102. In addition to a gimbal angle, an estimation of the individual CMG momentum vectors which may be determined by knowledge of the inertial mass about its spin axis and a sensor that determines the rotational speed may be used.

The appropriate amount of thrust may be determined within the algorithm and the nozzles 708 therein may be used to generate enough torque 604 to counteract the saturation within the CMGs 102. Through the channel 804, torque 604 may be provided to deplete the residual momentum through a combination of aero-control surfaces.

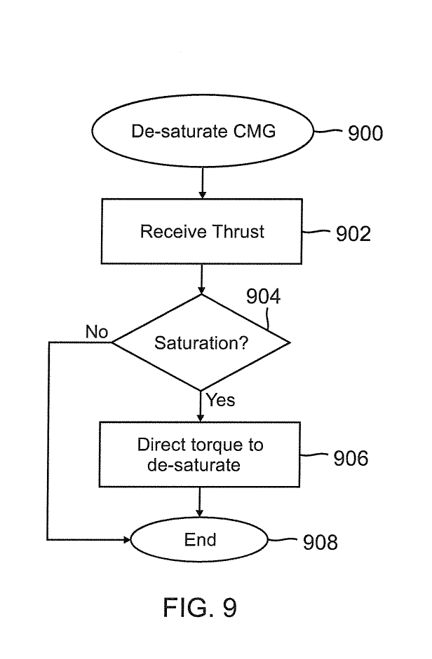

Referring to FIG. 9, a flow chart providing illustrative processes for desaturating the CMGs 102 may be shown. The processes for desaturation the CMGs 102 may begin at block 900. At block 902, the system may receive thrust. The thrust, as described above, may come from a variety of sources including outside the aircraft 602 through an air intake 702. Alternatively, the thrust may be bleed air received from a propulsion device.

Saturation of the CMGs 102 may be detected at decision block 904. When saturated, or above the threshold where desaturation is desired, the useful torque and momentum transfer provided by the CMG 102 may be limited. The saturation may be detected by an algorithm or other control circuitry within the array 102 or other control processor. The momentum state may be calculated with an estimation of the stored angular momentum in the individual CMGs along with knowledge of their relative angular orientation through vector math/algorithms. When no saturation has been detected, the processes may end at block 908. Otherwise, the system may direct torque 604 to desaturate the CMGs 102 at block 906. The amount of torque 604 to desaturate the CMGs 102 may be computed by the algorithm. Furthermore, nozzles 708 may be either fixed or maneuverable by the algorithm to redirect the airflow. The processes may end at block 908.

The features presented herein may be extended to other technologies. For example, the system may be converted such that reaction wheel arrays may be desaturated. Other angular momentum storage systems that combine various momentum devices may also be desaturated using those features presented above.

The data structures and code within the software 806, in which the present disclosure may be implemented, may typically be stored on a non-transitory computer-readable storage. The storage may be any device or medium that may store code and/or data for use by a processor. The non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the disclosure may be embodied as code and/or data, which may be stored in a non-transitory computer-readable storage medium as described above. When a computer system reads and executes the code and/or data stored on the non-transitory computer-readable storage medium, the computer system performs the methods and processes embodied as data structures and code and stored within the non-transitory computer-readable storage medium. Furthermore, the methods and processes described may be included in hardware modules. For example, the hardware modules may include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The technology described herein may be implemented as logical operations and/or modules. The logical operations may be implemented as a sequence of processor-implemented executed steps and as interconnected machine or circuit modules. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiment of the technology described herein are referred to variously as operations, steps, objects, or modules. It should be understood that logical operations may be performed in any order, unless explicitly claimed otherwise or a specific order is inherently necessitated by the claim language.

While embodiments of the disclosure have been described in terms of various specific embodiments, those skilled in the art will recognize that the embodiments of the disclosure may be practiced with modifications within the spirit and scope of the claims.

What is claimed is:

1. A method for adjusting a control moment gyroscope array comprising:
receiving a stream; and
directing the stream to adjust momentum in the control moment gyroscope array.

2. The method of claim 1, comprising detecting saturation of the control moment gyroscope array.

3. The method of claim 1, wherein receiving the stream comprises extracting bleed air from a propulsion device.

4. The method of claim 3, wherein extracting the bleed air from the propulsion device comprises obtaining the bleed air from a compressor of the propulsion device.

5. The method of claim 1, wherein directing the stream to reduce the momentum in the control moment gyroscope comprises maneuvering at least one nozzle in a coordinated direction to produce a desired torque.

6. The method of claim 1, wherein directing the stream to reduce the momentum in the control moment gyroscope comprises selecting at least one fixed nozzle to produce a desired torque.

7. The method of claim 1, wherein directing the stream to adjust the momentum in the control moment gyroscope comprises driving momentum in the control moment gyroscope to a desired state or threshold for generating a bias in large momentum maneuvers.

8. A control moment gyroscope array comprising:
a plurality of control moment gyroscopes (CMGs) having saturated angular momentum; and
a channel receiving airflow for adjusting the angular momentum residual.

9. The control moment gyroscope of claim 8, wherein the channel comprises an air intake, duct and manifold system and at least one valve and nozzle.

10. The control moment gyroscope of claim 9, wherein the at least one nozzle is maneuverable.

11. The control moment gyroscope of claim 9, wherein the at least one nozzle is fixed.

12. The control moment gyroscope of claim 8, comprising software for determining an amount of the airflow for removing the saturated angular momentum.

13. The control moment gyroscope of claim 8, comprising software for determining whether a rotor is saturated.

14. The control moment gyroscope of claim 8, comprising a propulsion device for providing the airflow.

15. A system comprising:
a control moment gyroscope array; and
at least one channel vectoring thrust to the control moment gyroscope array for adjusting angular momentum.

16. The system of claim 15, comprising a propulsion system for providing the thrust.

17. The system of claim 15, comprising an air intake for providing the thrust.

18. The system of claim 15, wherein the thrust comprises bleed air and other vectored air.

19. The system of claim 15, wherein adjusting the angular momentum comprises desaturating or adjusting to a desired momentum state.

20. The system of claim 15, comprising aero-control surfaces combined with the thrust for adjusting the angular momentum.
